(19) United States
(12) Patent Application Publication
(10) Pub. No.: US 2010/0250022 A1
(43) Pub. Date: Sep. 30, 2010

(54) Useful unmanned aerial vehicle

(75) Inventors: Destry Hines, San Antonio, TX (US); Jason Watts, San Antonio, TX (US); Donald E. Watts, Eugene, OR (US)

Correspondence Address: JACKSON WALKER, L.L.P., 112 E. PECAN, SUITE 2400, SAN ANTONIO, TX, 78205, US

(73) Assignee: AIR RECON, INC.

(21) Appl. No.: 11/647,986

(22) Filed: Dec. 29, 2006

(51) Int. Cl. G05D 1/00; B64C 13/20; G06F 3/048

(52) U.S. Cl. 701/2; 244/190; 715/771

(57) ABSTRACT

An unmanned aerial vehicle (UAV) addresses remotely piloted UAVs making them easier to operate, provide a more flexible positioning system, also improving on communications latency and interference problems. The UAV sends symbolic messages to an educated public via color.

### FIELD OF THE INVENTION

The present invention relates to structures and methods to make unmanned aerial vehicles (“UAVs”) more useful and practical by making them easier to operate, providing a more flexible positioning system, addressing communication disruption and latency issues to improve remote UAV piloting and addressing symbolic meaning issues, which affect use of UAVs as a visual communication method.

### BACKGROUND OF THE INVENTION

UAVs are remotely piloted or self-piloted (“autonomous”) aircraft. The public perception of UAVs is often of high-tech military units that provide surveillance from above the battlefield; in many domestic cases they are perceived as tiny model kit airplanes buzzing around a local sports or hobby field, but practical UAVs are typically much larger. In fact, some UAVs are as large as a small manned airplane. The United States military uses large Predator UAVs to support combat troops in places like Iraq and Afghanistan.

In industrial or public service applications, UAVs are typically larger than toy airplanes and smaller than a small manned aircraft. Such UAVs typically fly closer to the ground than small manned aircraft and typically fly further away from the controller than toy UAVs. They may be used in relatively low or high altitude missions, sent on long linear distances, used to loiter over urban centers, sent to follow moving targets, etc.

Because of increasing interest in non-military use of sophisticated UAVs, the Federal Aviation Administration (FAA) recently formed an “Unmanned Aircraft Program Office.” Its mission is to “safely integrate Unmanned Aircraft Systems into the U.S. National Airspace System.” This office is currently developing a 5-year roadmap to safely integrate the increasing use of UAVs into the nation's airspace. The roadmap document is to be available in March 2007.

These conditions present various problems to be solved and opportunities to be seized.

Airplanes have had visible identification markings almost from their inception. These typically convey such information as country of origin, line of military service, military unit designations and ownership by a particular commercial carrier. For example, at the beginning of World War II, the United States Army Air Forces used a simple alpha-numeric designation to indicate an aircraft's squadron and to identify the specific aircraft. As the number of aircraft increased throughout the war, additional schemes, including stripes of colors and simple geometric shapes, provided more ready unit identification. Eventually, some units even adopted a special pride in their paint schemes. For example, the Navy's famous VF-17 squadron adopted the nickname “Jolly Rogers” and painted their aircraft with black tails, yellow tips and a distinctive skull and crossbones design. Because VF-17 was one of the Navy's most effective squadrons, the color scheme was intended to serve as an immediate and fateful warning to enemies, and VF-17's successor (VF-103) still proudly carries the insignia today. In a similar (though less sinister) vein, a bold orange and gold paint scheme on a commercial Boeing 737 will immediately indicate to an observer that the plane he sees is operated by Southwest Airlines.

Extending their communicative abilities, aircraft have also been used to pull banners, drop signal flares, and even for skywriting. But the full communicative possibilities of UAVs have not been exhausted. Furthermore, industrial size UAVs may be viewed by persons on the ground as Unidentified Flying Objects (“UFOs”), as large toys, or with hostility and suspicion. Industrial size UAVs may be politically unpopular and, in some cases, may even be shot at. These facts are detrimental to UAV use. An embodiment of the present invention facilitates visual communication from UAVs to persons on the ground or elsewhere.

UAVs can also receive and/or relay information. UAVs can carry cameras, sensors, communications equipment or other payloads, and they can provide intelligence, surveillance, reconnaissance, and command and control information to ground personnel.

Historically, there have been two predominant means of UAV control: fully autonomous control and remote manual control. A remotely-piloted UAV is highly reliant on uninterrupted two-way communications, and is intolerant of any meaningful communication latency. The data link relays signals from the UAV's sensors to the remote controller and relays instructions from the controller to the UAV in real-time or near real-time. But remote communications are vulnerable to interference from a multitude of sources, both natural and man-made. In some situations, if a transmission is interfered with for only a few moments, the disruption produces profound effects up to and including complete loss of the UAV.

A fully autonomous UAV is capable of using its own systems, including automatic target recognition or pre-programmed waypoints, for control and navigation. The degree of autonomy increases as the UAV possesses an increasing capability to sense changes in conditions and make appropriate responses to those changes to accomplish its mission. Such changes in condition will include changes in speed, direction and location of a target.

One of the benefits of an autonomous UAV is decreased reliance on real-time or near-real-time communication. But an autonomous UAV still needs to receive updated information and mission changes and still must transmit its data back to the controller. Unlike in the manually-controlled UAV, the autonomous UAV's data link is not directly tied to its control systems, so it is less vulnerable to latency and data-link failures. But even autonomous UAV flights may be affected by unexpected conditions that require course adjustment and two-way communications. For example, if the target is mobile, the autopiloted UAV may be unable to effectively respond.

Furthermore, fully autonomous UAVs are expensive and complicated. So most rely upon some degree of communication with the control station. Ultimately, therefore, in all but rare instances, communication between the UAV and a controller or data source is mission critical.

Unfortunately, communication between the ground station controller and the UAV may be unpredictably interrupted by weather, buildings, electrical discharges, electrical interference, etc. When communications are interrupted critical real-time or real-near-time control can be lost. At a minimum, this can mean damage to or loss of the UAV. If it happens over a populated area, the results can be tragic.

Signal latency is another critical concern. The UAV is moving and signals must travel a finite distance, so real-time and near real-time communication can be degraded. In some environments, such as transmission over satellite systems, the latency is so severe that real-time or near-real-time control is effectively lost.

References in the literature, such as Schwaerzler, U.S. Pat. No. 6,377,875; Bodin, et al., U.S. Pat. No. 6,856,894 and Frink, U.S. Pat. No. 6,868,314, disclose some embodiments that partially address these issues. Bodine '894 discloses a method of piloting a UAV under the control of a navigational computer on the UAV from the UAV's starting position to waypoints in accordance with a navigation algorithm and changing from piloting the UAV under control of a navigational computer on the UAV to piloting the UAV under manual control. Frink '314 discloses a UAV adapted to fly in a flight pattern relative to a moveable surface object. Schwaerzler '875 discloses a method of avoiding uncontrolled flight of a UAV upon loss of radio contact by flying the UAV on a preprogrammed safety route.

While these and other proposed solutions are steps in enabling UAVs to be used for public and industrial purposes, their solutions to the problems of communication latency and disruption are imperfect. The fact that there are not large numbers of UAVs patrolling the skies on industrial, public use and public communications missions testifies that the issues of latency, disruption and public recognition of UAVs have not been solved. In fact, despite the long-recognized need for industrial and public UAV missions, many governments and companies are unwilling to assume liability for the risk of uncontrolled UAVs crashing and causing damage or flying into restricted areas.

The problems of communication latency and disruption and the public mistrust, therefore, affect the marketability of UAVs. An embodiment of the present invention addresses these problems.

### BRIEF DESCRIPTION OF THE DRAWINGS

FIG. 1 is a schematic diagram of a symbolically-colored UAV 104 communicating a message to a target audience 24 via the UAV's color 22.

FIG. 2 is a schematic diagram overview of the systems involved in Follow Flight mode.

FIG. 3 is a simplified example of the user interface the operator uses to control the UAV.

FIG. 4 is a schematic diagram of the target offset relationship between the UAV and the target.

FIG. 5 is a schematic diagram showing an example of how the UAV moves as it tracks the target offset through a turn.

FIG. 6 shows events, message flows and actions in an exemplary embodiment of the invention for Follow Flight Mode when the target is an actual target whose location is provided to the ground station.

FIG. 7 shows events, message flows and actions in an exemplary embodiment of the invention for Follow Flight Mode when the target is a Simulated Target controlled by the operator.

FIG. 8 is a schematic diagram overview of the systems involved in Hybrid Flight mode.

FIG. 9 shows how the operator would see the elements of Hybrid Flight Mode represented on the computer screen

FIG. 10 shows a 3 step diagram showing the flight progression of the UAV as it adjusts its heading to meet the offset heading.

FIG. 11 shows how adjusting the control radius will adjust the maneuverability of the UAV when the autopilot is designed to turn tighter when the target or waypoint is closer versus wider, more gradual turns when the target or waypoint is farther away.

FIG. 12 shows a side-view representation of how the UAV would adjust elevation while in Hybrid Flight Mode

FIG. 13 shows events, message flows and actions in an exemplary embodiment of the invention for Hybrid Flight Mode.

FIG. 14 shows how the shadow is cast below the UAV icon on the operator's 2D display that provides visual feedback of the altitude AGL (above ground level).

### DETAILED DESCRIPTION OF THE PREFERRED EMBODIMENT

### Definitions

Autopilot—Autopilots mechanically guide a vehicle without assistance from a human being. Most people understand “autopilot” to refer specifically to aircraft, but autopilots for boats and ships are called by the same name and serve the same purpose.

Autopilot Flight Mode—This flight mode is when the flight computer is autonomously flying the aircraft to a series of one or more waypoints.

Control Radius—In Hybrid Flight Mode, an offset that the autopilot maintains from the Target Position. The operator may adjust the control radius to increase or decrease the responsiveness of the flight system.

Flight Mode—This is the functional state in which the flight computer is operating at any given time. The operator can change the flight mode of the UAV from the ground station to meet the current mission requirements. Some flight modes require the complete control and attention of the operator to keep the aircraft in the air while other flight modes allow the UAV to pilot itself.

Follow Flight Mode—This flight mode is when the UAV is following a single moving Target that is either a “real” Target whose position and speed is being relayed to the Ground Station, or is a Simulated Target that the operator is controlling from the Ground Station software.

Graphical Position—The position of an element on a graphical user interface (GUI) that is a symbolic representation of its real-world position. For example, on an overlaid map, an offset heading indicator may be used

Heading—The direction toward which an aircraft or other vehicle is oriented.

Hybrid Flight Mode—This flight mode is a cross between manual and fully autonomous flight. The operator is steering the UAV by using the yoke or other controller to specify the heading, altitude, speed and Control Radius (which determines maneuverability) of the UAV. This information is then sent to the UAV's onboard flight computer, which keeps the UAV in safely controlled flight while it adjusts to meet the new instructions from the operator.

Manual Flight Mode—This Flight Mode is when the operator of the aircraft is in direct control of the aircraft and there are no autonomous inputs from the flight computer. This flight mode is the same as someone flying an RC airplane.

Offset Altitude—In Follow Flight Mode the offset altitude is the altitude relative to the target that the UAV is instructed to maintain. In Autopilot Flight Mode the offset altitude is the altitude relative to the target that the UAV is instructed to reach.

Offset Heading—In Follow Flight Mode the offset heading is the heading relative to the target heading that the UAV is instructed to maintain. In Autopilot Flight Mode the offset heading is the heading relative to the target heading that the UAV is instructed to reach.

Offset Position—In Follow Flight Mode and Autopilot Flight Mode the Offset Position is the Position relative to the Target the UAV is to maintain or reach, calculated from the Offset Radius, Offset Heading and Offset Altitude.

Offset Radius—The distance from the target position that the UAV is instructed to maintain.

Position—A location specified in terms of latitude, longitude and altitude.

Probable Flight Path—In Autopilot Flight Mode, a visual indicator displayed on the ground station monitor that shows the operator what path the UAV will probably take to reach the Target or Offset Position. In manual mode, the path the UAV will take on its current course. In hybrid mode, the path the UAV will take until it reaches and maintains the target heading, speed and altitude. The Probable Flight Path is based on an internal flight simulation on the ground station computer based on the flight characteristics of the UAV.

Simulated Target—A “virtual” Target that the Operator controls with the ground station software that simulates an actual target. To the UAV a Simulated target is not discernable from an actual target. This allows an operator to track a moving target manually like an automobile based on visual queues or information relayed to them. For example during a police pursuit of a vehicle, the operator could be relayed information about the position and speed of the fleeing vehicle and could match the simulated target's speed and location, making corrections as they are available. Alternatively, a map can be overlaid on a video feed of a fleeing vehicle, and the operator can use a controller to maintain the simulated target over the image of the vehicle.

Target—A Position that the autopilot uses as a point of reference towards which to navigate the aircraft. Some targets are fixed, while others move. The target position is not necessarily the actual point-in-space that the autopilot navigates to. Instead the autopilot may be given a “Target Offset.” For example, the target may be on the ground, in which case the aircraft will need to maintain a safe distance above the ground to avoid crashing into anything. Fixed Targets are similar to conventional Waypoints but they have additional attributes such as Target Offset (Distance, Altitude and Heading). In Follow Flight Mode the Target is either a moving object whose position is sent to the UAV or a Simulated Target the Operator controls with the ground station whose position is sent to the UAV. In Hybrid Flight Mode the Target is a position that is continuously recalculated using the Offset (Heading, Altitude and Control Radius) from the UAV's current position, which the autopilot flies the UAV towards. In Autopilot Flight Mode the Target is similar to a conventional Waypoint with the additional attributes a Target can have such as Offsets.

Target Altitude—In Hybrid Flight Mode this is the altitude the UAV is instructed to ascend or descend to and maintain. In Follow Flight Mode the Target Altitude is the altitude of the moving target. In Autopilot Flight Mode the Target Altitude is the altitude of the Target (Waypoint).

Target Heading—The Target Heading in Hybrid Flight Mode is the Heading the UAV is instructed to turn to and maintain. In Follow Flight Mode the Target Heading is the current direction of a moving target. In Autopilot Flight Mode the Target Heading is the Heading relative to the UAV of the current Target (Waypoint).

Target Position—In Follow Flight Mode the Target Position is the latitude, longitude and altitude of the Target being followed. In Hybrid Flight Mode the Target Position is the continuously recalculated position using the Offset (Heading, Altitude and Control Radius) from the UAV's current position which the autopilot flies the UAV towards. In Autopilot Flight Mode the Target Position is similar to a conventional Waypoint with the additional attributes a Target can have such as an Offset.

Target Offset—A specified offset relative to the Target Position and Target Heading, towards which the autopilot will navigate. The offset includes heading, radius and altitude values relative to the values of the target.

Terminal Waypoint—The final Waypoint defined for a UAV's mission. Preferably, the UAV will land at the Terminal Waypoint, but it is also possible it may loiter and wait for additional instructions.

Waypoint—A waypoint is a fixed location with a specified longitude and latitude, which marks a destination, a point along the way to a destination, or a point of reference. In a typical mission multiple waypoints are defined and while in Autopilot Flight Mode the UAV will automatically fly to each consecutive waypoint. When the UAV reaches each waypoint the Flight Control System will read the instructions programmed into that Waypoint. These instructions can be simple things like “Fly to Next Waypoint” or “Fly to Waypoint 12”, or they can be more complex instructions based on a script like payload control. The distinction between Waypoints and Targets in this system.

Wingspan—Wingspan is measured from an aircraft's starboard (right) wingtip to its port (left) wingtip in a fixed-wing aircraft. The measurement can also apply to rotor-wing aircraft, lifting bodies, cylinders, disks, balloons and dirigibles. The term is gives a general impression of the size of an aircraft.

### Symbolic Color Communication

In one embodiment of the invention, UAVs are color-coded to enable the UAVs to visually communicate one of a set of predetermined messages to educated target persons on the ground. In one embodiment, a general UAV may have a preferable wing span between about six inches to about 80 feet, and travel at a height between about 10 feet above ground level (AGL) to about 50,000 feet above sea level, and travel at a speed between a stationary hover and mach 2. UAVs useful for symbolic color communication, however, have a preferable wing span of about 12 feet to about 24 feet, travel at a height between about 100 feet AGL to about 10,000 feet AGL and fly at speeds between about 30 miles per hour to 130 miles per hour. The UAV may be positioned to loiter and/or hover over a limited area (such as a school zone or a search zone for a missing child), sent on a long journey (such as over a pipeline, river or highway), or sent to inspect an area such as a forest or border area.

In one embodiment, a color-coded UAV is positioned above a selected locale or sent upon a selected route and while on that mission visually communicates one of a set of predetermined symbolic color messages to educated target persons on the ground. As non-limiting examples, blue UAVs are used by and restricted to airborne operations for law enforcement, red UAVs are used by and limited to airborne operations for fire departments, yellow UAVs are used by and restricted to search and rescue and safety operations, black UAVs are used by and restricted to airborne operations for special weapons and tactics (SWAT) units or other special operational applications; white UAVs are used by and restricted to airborne operations for commercial applications; green UAVs are used by and restricted to airborne operations for environmental applications; and brown UAVs are used by and restricted to airborne operations for forestry applications. In these examples, the colors chosen reflect associations already held by the public when possible (e.g., red is associated with fire departments because of red fire trucks, blue is associated with police because they wear blue uniforms, and so forth). But other colors can be matched to other messages.

Preferably, a limited set of symbolic colors is used. As the number of color shades and/or combinations increases, the requisite public education becomes more complicated. More complication means fewer members of the public will learn and remember what the colors signify, and the communicative purpose will be frustrated. Indeed, communication fails with a member of the public who does not remember the symbolic meaning of a UAV color even if it is stationary and directly in front of him, much less one that is far overhead and moving. Evidence of this effect lies in the well-known public confusion caused by the United States Homeland Security Department's well-intentioned use of color codes to communicate different terror threat levels.

The issue of an upper limit on the number of colors usefully used is further exacerbated by the relatively small size, large distance and high speed of a UAV traveling above the UAV's intended target audience. So the preferable color coding scheme in an embodiment of the invention is limited to between five and ten colors.

In a setting where the intended observers are expected to be highly or specially educated, more complicated color schemes and combinations may be used. Such groups may include forest rangers, military personnel, government employees and oil field and other industrial workers. For example, a UAV with white wings and a gold body may indicate industrial use (white wings) by Exxon (gold body). In the extreme case, an intentionally obscure color combination may be used to communicate a very specific encoded message to a limited audience, for example in a SWAT, Special Forces or intelligence application. In one such embodiment, organic light-emitting diodes (OLEDs) formed as the skin of the UAV, as disclosed in Frink (U.S. Pat. No. 6,868,314), may be used to make the UAV's color scheme easily configurable both before flight and in response to commands sent to the UAV in flight or under the direction of a pre-programmed algorithm. By this method, the UAV's symbolic message can be conveyed not only by a fixed color scheme, but also by an alternating color scheme.

As another example, the Amber alert system is currently successfully used to communicate to persons in a target area that a child in the target area is in danger and that persons in the target area should be on the lookout for the child. The amber signal is communicated through signs on highways and messages on radio and TV in the target area. The Amber alert system works because it is simple and a public educational campaign has successfully educated the public concerning the symbolic meaning of its one color—amber.

In one embodiment, an amber-colored UAV with a wing span of between about 8 to about 18 feet slowly loiters over a selected target area at a speed of between about 30 to 130 miles per hour at a height of between about 500 to about 5,000 feet AGL. This UAV would attract attention to itself. A substantial number of persons in the target area who have been the subject of a public educational campaign to educate them concerning the symbolic message of an amber UAV and who see the low flying, large, amber-colored UAV recognize it as a signal that they are the intended target audience of a lost child/child in danger amber alert warning. If even five percent of the persons who see the UAV recognize its message, then the communicative act is deemed successful. In an alternative embodiment, a sufficiently-visible UAV with a skin made wholly or partially of OLEDs may be configured to also scroll an informative message such as “MISSING CHILD” and a description of a vehicle, license plate and/or person to look for.

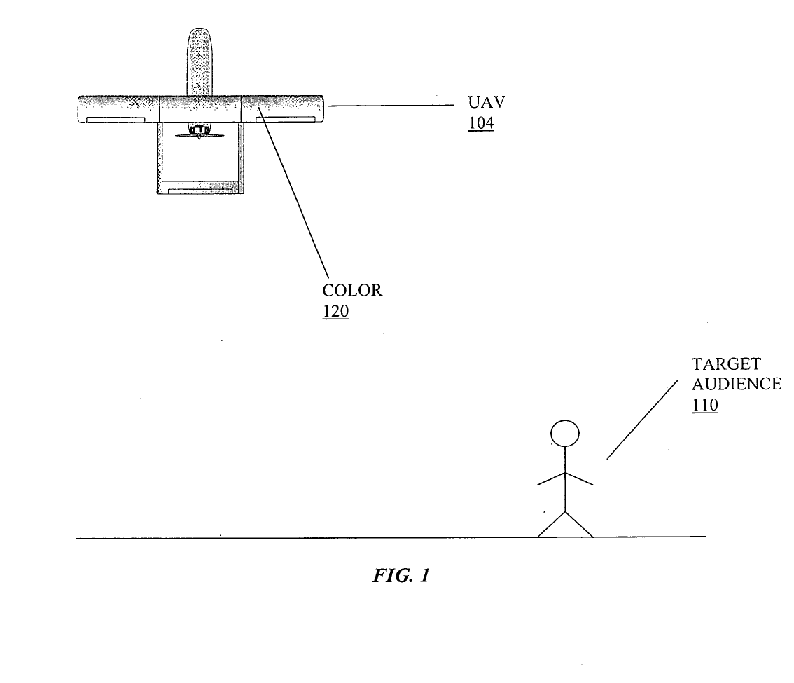

FIG. 1 is a schematic diagram of a symbolically colored UAV communicating a color coded message to an educated target audience. A person 24 educated concerning UAV color schemes sees UAV 20 with its color 22. The person can then act on that message by being alert, seeking additional information or taking other amber-colored UAV driven action.

In one embodiment, the method of using unmanned aerial vehicles (“UAV”) to visually communicate information comprises:
(a) selecting a limited number of messages, preferably from five to ten messages;
(b) selecting a limited number of colors, the selected limited number of colors being equal to the selected limited number of messages;
(c) associating each selected message with exactly one selected color to create symbolic message/color pairs;
(d) directing an educational campaign regarding the symbolic association of each of the selected colors and messages to a target group or groups of persons in one or more locales;
(e) selecting a message from among said group of limited number of messages;
(f) selecting a locale to which the selected message is to be communicated, said selected locale being chosen from among the group of locales having said education target group of persons to whom said educational campaign was directed;
(g) launching a UAV into flight, the UAV having a wing span of at least 4 feet, the primary color of the UAV corresponding to said selected message;
(h) flying said UAV whose primary color corresponds to said selected message over said selected local having at least some of said educated target group of persons, at a speed from 30 to 300 miles per hour and at a height of between 100 and 10,000 feet;
(i) communicating said selected message to at least some of said educated target group of persons situated at said selected locale by flying said UAV whose primary color corresponds to said selected message over said selected locale, at a speed from 30 to 130 miles per hour and at a height of between 500 and 5,000 feet AGL.
(j) the above steps being effective to symbolically communicate said selected message to at least some persons at said selected locale.

Another embodiment additionally comprises fixing an audio speaker on the UAV and broadcasting an audio message consistent with the color message of the UAV and which audio message can be heard and understood by at least some of the target population on the ground below the UAV. The combination of color message and the audio message is more likely to collectively communicate the selected message than either color or audio separately.

Another embodiment additionally uses colored lights which are consistent with the selected symbolic color message

### Follow Flight Mode

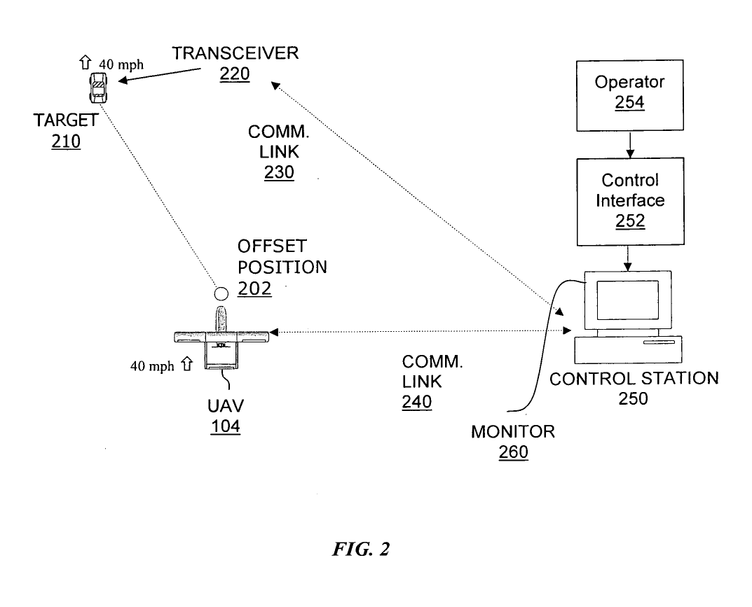

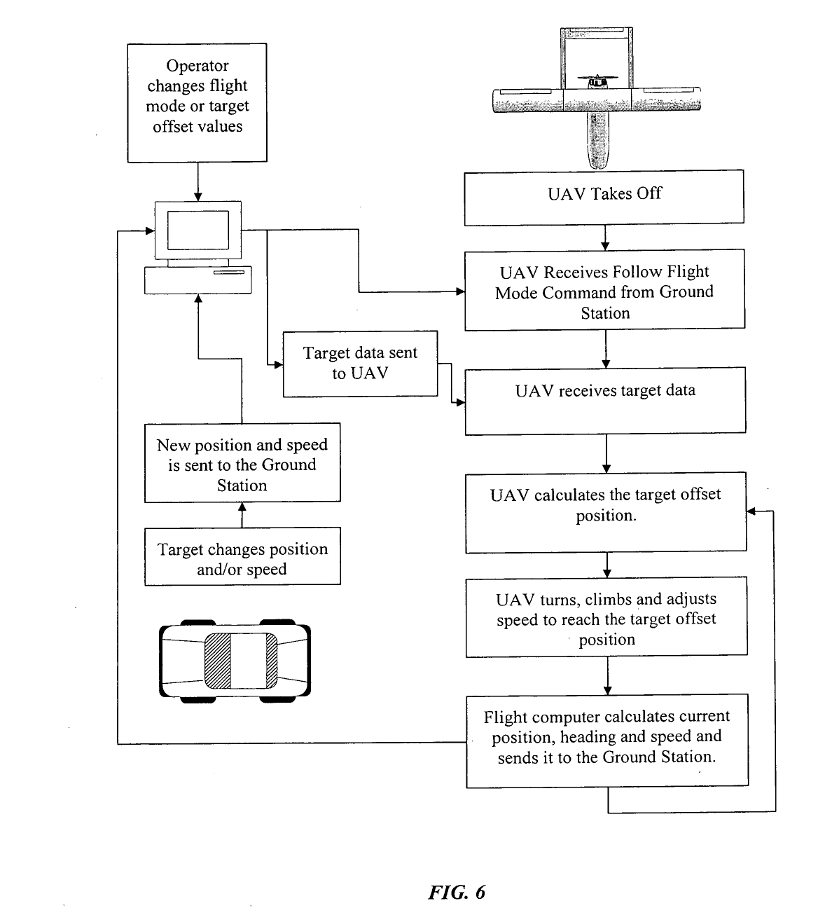

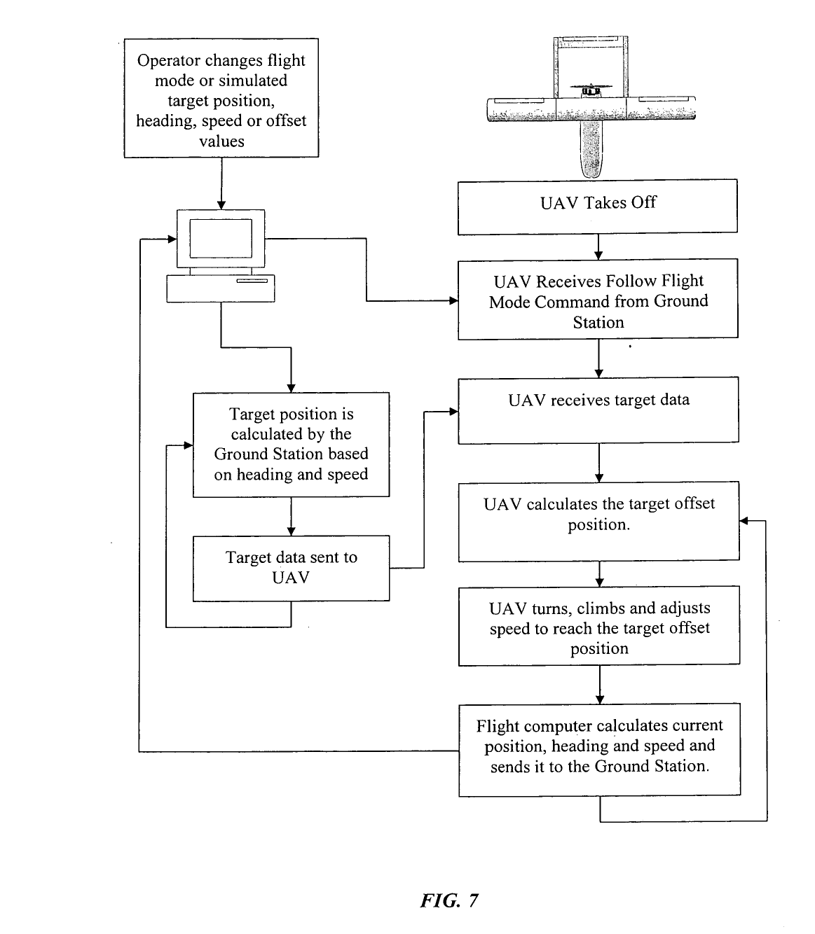

FIGS. 2-7 comprise a schematic diagram overview of the systems involved and the basic interactions between operator 106, ground station 98 and UAV 104 to accomplish Follow Flight Mode. Follow Flight Mode is a mode in which the UAV 104 is adapted to navigate autonomously in relation to a Target 100 provided by control station 98. The Target 100 is a either a Target whose Position is relayed to the ground station from a transponder affixed to the target, or is a Simulated Target controlled by the operator, so that its Position is transmitted to the UAV's 104 flight computer from the ground station. The Target 100 Position transmitted to the UAV comprises at least minimal Position information, including latitude, longitude, and altitude. The UAV's flight computer flies the UAV toward the Target as it would fly the UAV to a stationary Waypoint.

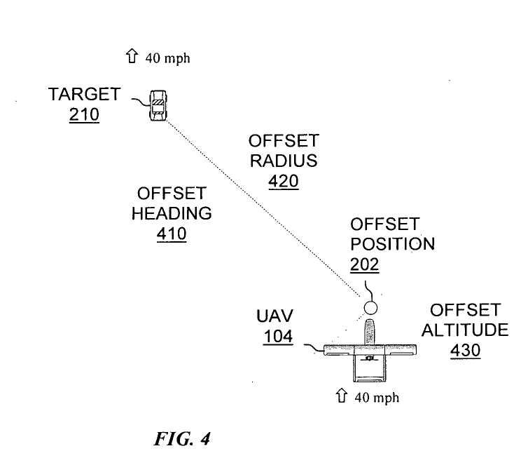

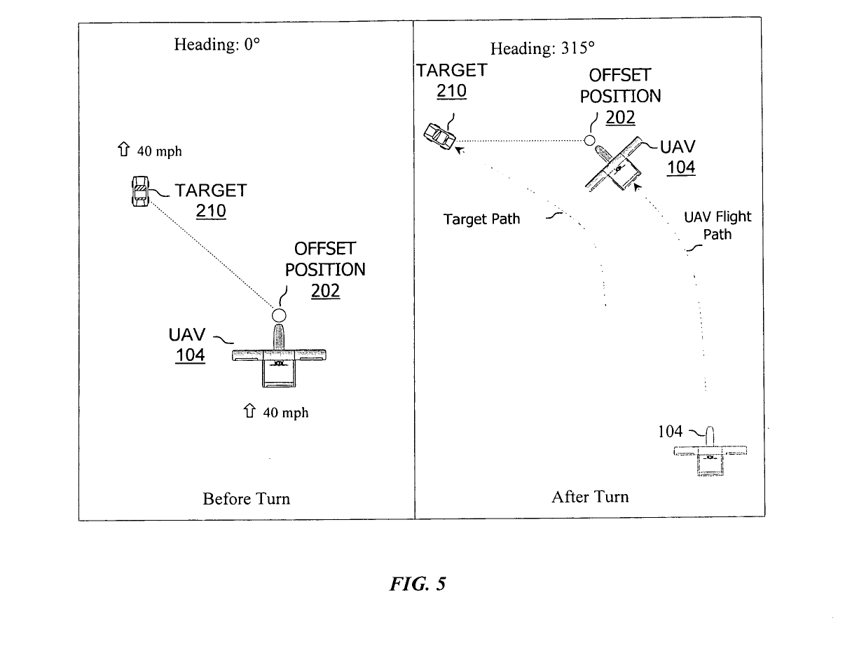

The follow position (Offset Position) of the UAV in relation to a Target can be set for distance (Offset Radius), degree (Offset Heading) and elevation (Offset Altitude) as illustrated in FIG. 4. The position is relative to the heading and speed of the Target so when the Target turns or changes speed so does the UAV in relation to the Target. This is illustrated in FIG. 5.

The operator can adjust the Offset Position so the UAV's onboard sensors can be positioned wherever needed in relation to the target. For example, the UAV 104 may be instructed to navigate to a Target 100 with an Offset Radius of 200 meters, an Offset Altitude of 100 ft and an Offset Heading of 90 degrees. For example, if the UAV has a side-mounted payload camera and the objective is to train the camera on a moving vehicle, the UAV can be positioned at a 90 degree angle to the target vehicle and flown at the same speed as the vehicle and the camera can be kept on the vehicle.

In one embodiment, the ground station receives the moving Target's then-current position and vector information. The ground station then transmits the moving target's current position and vector information to the UAV.

If the UAV arrives at a Target but has received no further instructions from the control station, the UAV can enter a loiter pattern over the last Target Position.

In an embodiment, the Simulated Target is controlled by the ground station operator in real time or near-real time, much the way a driver or pilot would drive a car or fly a plane. The operator controls the UAV 104 by changing the position of Simulated Target 100. The operator's control is indirect because UAV 104 turns, changes altitude and changes speed in response to changes in the location of Simulated Target 100. As the Position of the Simulated Target changes, the information is sent from control station 98 over a communications link to UAV 104.

In another embodiment, a UAV and control station is provided as above. In addition, a GPS-enabled device is embedded in or attached to a mobile Target to which the UAV is to navigate. In this embodiment, the GPS-enabled device is equipped with a GPS receiver and a transmitter to transmit GPS coordinates to the control station. The GPS-enabled device may be manufactured into the mobile Target, added to the mobile Target as an “after-market” add on, attached to the mobile Target in an exigent situation such as a police car chase or otherwise movable together with the Target

In this embodiment, the GPS-enabled device continuously transmits the current location of the mobile Target to the control station. The control station converts the GPS coordinates to a Target Position and transmits the information to the UAV. In this fashion, the UAV is able to automatically follow a mobile Target without continued remote control guidance from ground forces. In an alternate embodiment, the UAV is adapted to receive the GPS coordinates directly from the GPS-enabled device.

In another embodiment, the autopilot on a UAV is programmed to follow a moving Target that is either (a) a Simulated Target manually moved by the UAV operator, or (b) is a real Target whose changing location information is transmitted to the ground station and forwarded to the autopilot. In another embodiment, the desired location of the UAV in relation to the target being followed can be set for distance and bearing so the sensors or cameras on the UAV can be positioned to a favorable angle and distance from the Target. The operator or remote transponder determines the location and direction of the Target, from which the UAV maintains a specific distance and bearing.

### Hybrid Flight Mode

In a specific embodiment, Hybrid Flight Mode is a mode in which neither the operator nor the Autopilot takes complete control of the UAV. The operator specifies a flight path by “steering” the UAV to a desired altitude, speed and heading. Upon the operator's input, the Autopilot adjusts control surfaces to execute the operator's commands while maintaining safe flight.

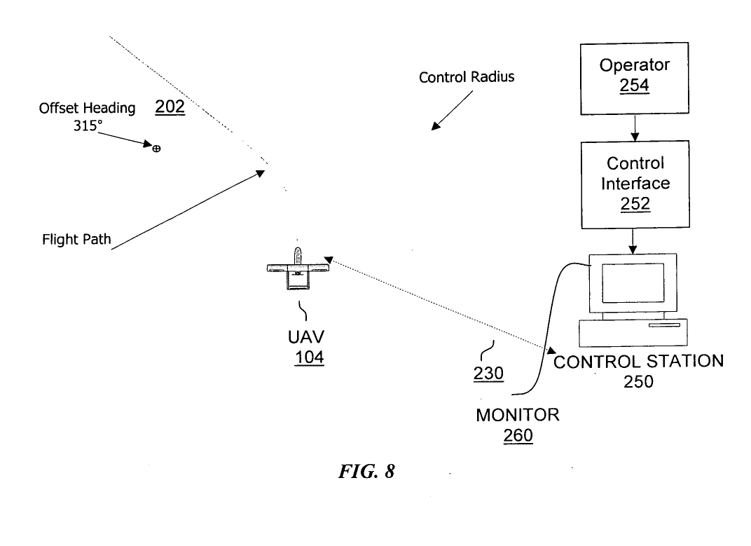

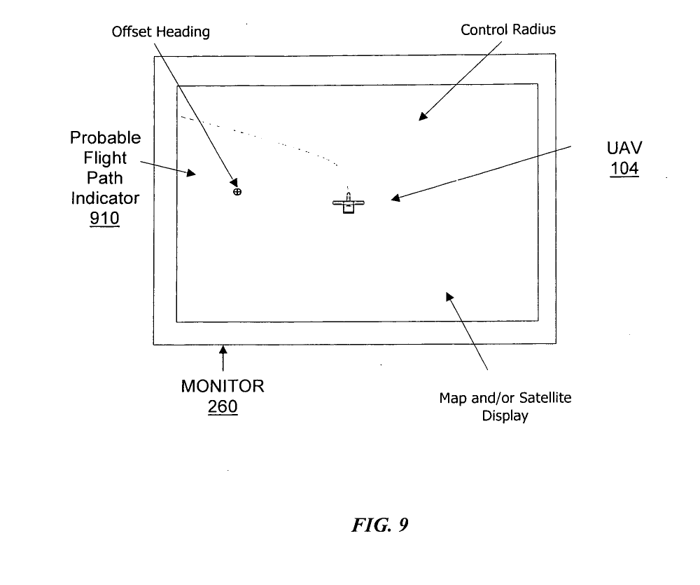

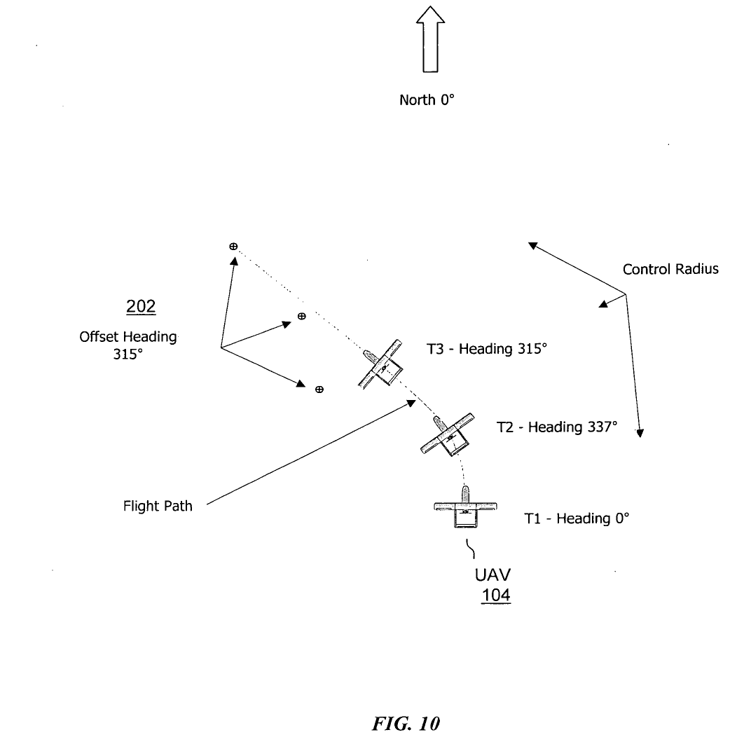

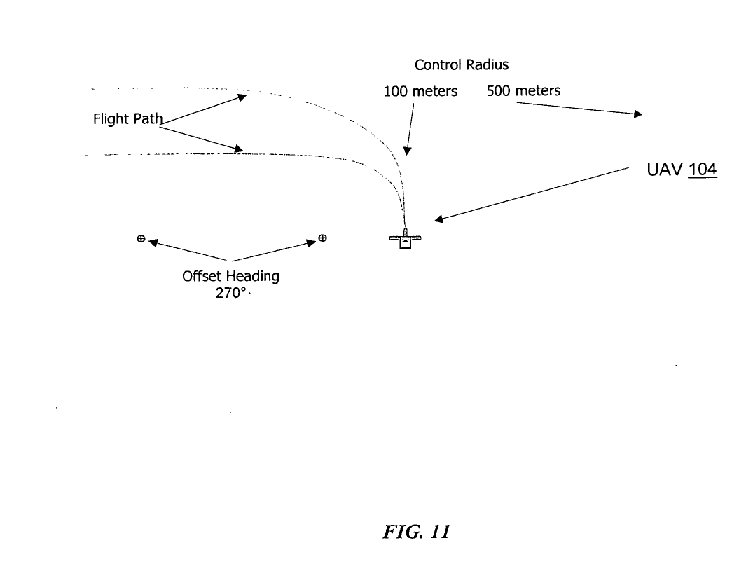

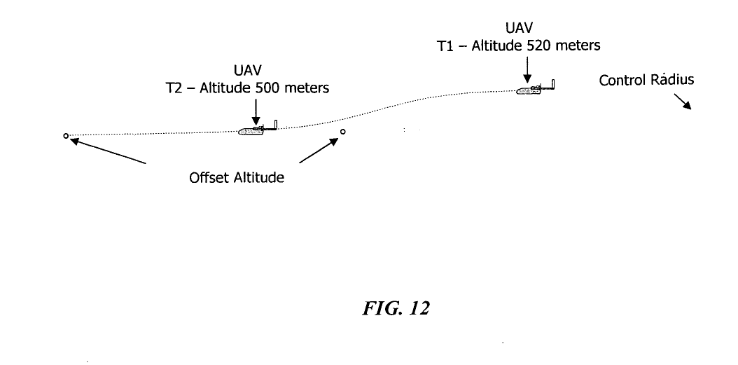

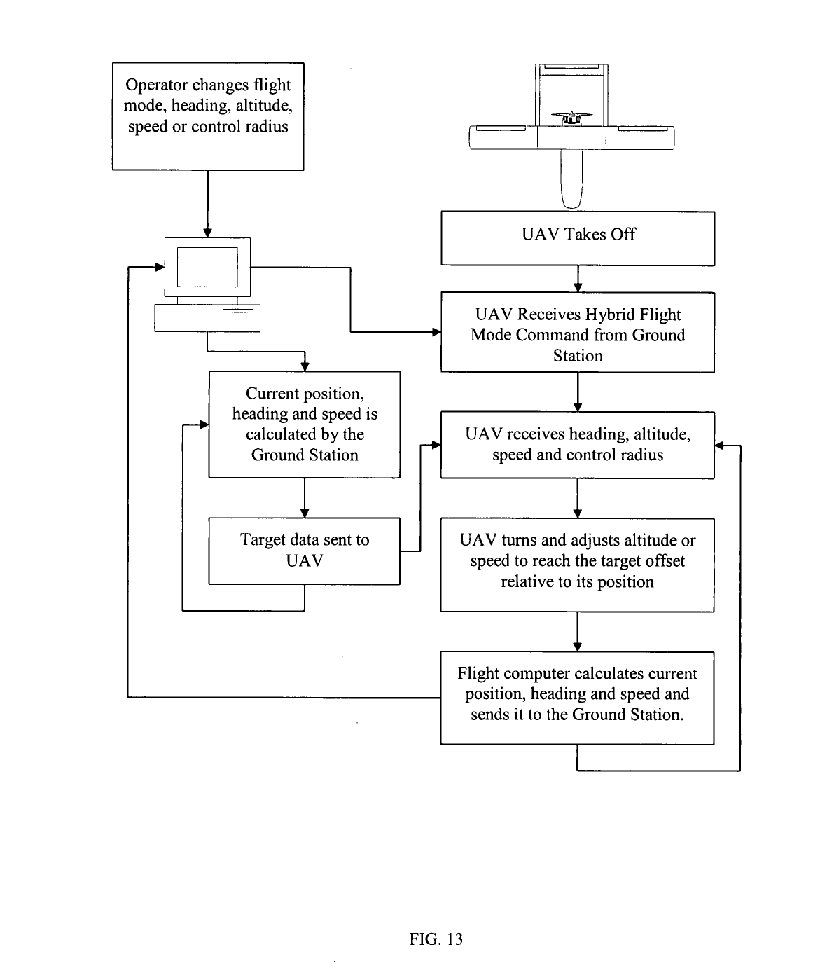

FIGS. 8-13 comprise a schematic diagram overview of the systems involved and the basic interactions between operator 106, ground station 98 and UAV 104 to accomplish Hybrid Flight Mode. FIG. 9 is a schematic of the control monitor in use. In one embodiment, operator 106 uses a control stick or wheel 108 to “drive” the UAV 104 in much the same fashion as driving an automobile. As operator 106 “steers” the UAV 104 the control station 98 software displays a probable path indicator 600 to show the path the UAV 104 will take to reach the heading, altitude and speed indicated by the operator. This allows the operator to direct the UAV 104 visually to any Target visible on the display by moving the probable path indicator 600 to intersect the Target.

The operator adjusts the UAV's 104 heading and altitude by using the control interface 108 attached to the control station 98, while watching the Probable Path Indicator 600 to see where the UAV will be flying. To change the flight path of the UAV the operator uses the control interface 108. Turning the control interface 108 left or right will progress the Offset Heading indicator left or right around the circumference of the circle. The greater the control input, the faster the heading changes, allowing the operator to have greater control of the UAV 100.

The UAV's 100 elevation is controlled in a similar way. A control signal from the operator changes the Target Altitude and the autopilot on the UAV adjusts the altitude accordingly.

Some advantages of using this method of remotely controlling the UAV are: the UAV's flight path can be controlled by the operator in a simple and intuitive manor similar to driving an automobile; the probable path of the UAV is displayed, allowing the operator to more easily fly the UAV to a Target; the operator does not need to continually determine and set new Targets; and the operator can manually designate the path of the UAV while the Autopilot keeps the UAV flying.

Hybrid Flight Mode permits an operator to control the flight of UAV even when communication latency would be prohibitive of true manual flight control, because once the operator has specified a desired heading, altitude and speed, even if communication is lost, the UAV Autopilot will maintain that heading and altitude until a new heading or altitude is specified, unless some other process of the flight computer takes over after communications have been down for a specified duration. If the UAV was in the process of curving to come to the correct heading, then it will continue to do so until the desired heading is reached. At that point the UAV straightens out its flight path and heads straight. The process for elevation changes is similar.

In one embodiment, a system to navigate a UAV is provided which comprises a UAV 104 and a control station 98. UAV 104 comprises at least a propulsion system, a transceiver, a Global Positioning System receiver or other means for accurately determining the UAV's position, a navigation computer, an altimeter, and a flight control computer.

The Global Positioning System (GPS) is a satellite-based radio navigation system initially developed and operated by the U.S. Department of Defense but now managed by an Interagency GPS Executive Board. GPS provides the navigational community with powerful tools for acquiring accurate and current locational data. GPS permits land, sea, and airborne users to determine their three-dimensional Position in all weather, anywhere in the world, with a high degree of precision and accuracy. Other means for determining a three-dimensional Position, including but not limited to tracking radar and inertial guidance systems, may also be used. In some embodiments of the present invention, UAV 104 will be equipped with surveillance equipment such as cameras (including infrared cameras), infrared and other sensors, radio receivers, and listening devices.

### Autopilot Flight Mode

In Autopilot Flight Mode, the UAV autonomously flies to a series of Waypoints, each of which is a Target.

The control station is equipped to program a series of Waypoints, which are transmitted to the UAV either before or during flight. Programming Waypoints may be accomplished through manual entry of absolute Waypoint Positions and Offsets, through selection of points on an interactive display that overlays the Waypoints on a map or through the automatic receipt of Waypoints from an outside data source such as a GPS device attached to a moving target. In some embodiments, the control station will be equipped with a device to read media on which Waypoints will be stored. CD-ROMs, DVDs, CF memory cards, SD memory cards and any other useful medial may be used. Also contemplated is the receipt of Waypoint data via wireless transmission such as Blue Tooth, 802.11, or infrared. When the control station transmits a Waypoint to the UAV, the new Waypoint can be transmitted (a) as a cumulative Waypoint added to the already programmed set of Waypoints to which the UAV will navigate, (b) as a replacement Waypoint, in which the new Waypoint completely replaces a prior programmed waypoint, (c) inserted at the head of the list of Waypoints but, once the UAV navigates to the new Waypoint, navigation to the original list of Waypoints is resumed, or (d) any other useful reorganization of Waypoints.

In one embodiment of the present invention, an operator programs the control station with a plurality of Waypoints to which the UAV will navigate. In this embodiment, the last Waypoint, called the Terminal Waypoint, is the Waypoint at which the UAV will land. Programming a series of successive waypoints is useful when the intended flight path of the UAV is known prior to the commencement of the flight. An example of such a situation is a UAV flight to visually inspect a pipeline. The locations of key points along the pipeline are known and can be programmed as Waypoints to instruct the UAV to follow the pipeline. Offset data may also be included to instruct the UAV to fly a predetermined Offset from the pipeline waypoints so that onboard cameras or sensors will be best oriented toward the pipeline. For example, the extended linear position of the pipeline can be calculated and input into the UAV's flight plan together with stand-off instructions such as a 90-degree angle to the right of the known pipeline at a 200-meter elevation

### Drop Shadow Altitude Indicator

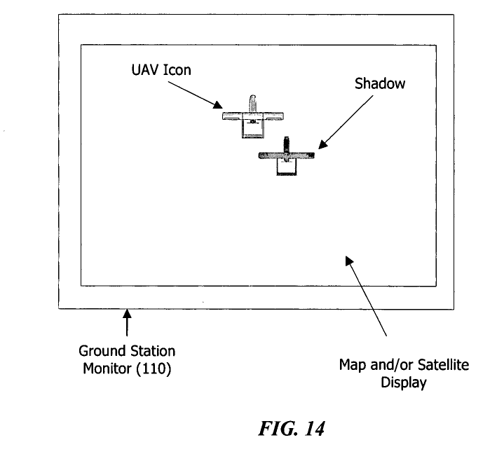

FIG. 14 comprises a specific embodiment of the visual display of the ground station which displays the map and icon representing a UAV or other aircraft. A shadow is displayed that is offset by the altitude of the UAV above ground level. This allows the operator to have a quick visual idea of the altitude with only having to look at the icon representing the UAV. The shadow is offset accurately based on the scale of the map so that if the UAV is 100′ above the ground the shadow would be offset by 100′ on the map at the current scale and zoom level. The location of the shadow can be anywhere that accurately depicts the correct distance but following many user interface conventions it's best placed at the lower right, simulating the sun being in the upper left.

### Additional Applications

This specification has described concepts for an improved navigation system and communicative abilities with respect to an UAV only. Although there are differences in design between UAV's and other unmanned vehicles, the applicable principles can be applied to a broad range of unmanned vehicles. As non-limiting examples, the same general principles will be useful in guiding an unmanned submarine or chase car, or an unmanned boat may be used for symbolic communication purposes.

### Other General Information

The UAV is equipped with a standard autopilot capable of directing the UAV 104 to any Target, including Waypoints. The UAV's 104 autopilot can accept real-time or near real-time changes in the Position of the Target. The UAV's autopilot uses the UAV's own Position and heading combined with the Target Position, heading and offset (if any) to determine the distance to the target. The autopilot then navigates the UAV to a Target Offset, which is either specified by the operator or calculated by the UAV flight computer based on a pre-programmed algorithm. There are many existing methods the autopilot can use to navigate to the target and maintain position at the Target Offset.

Control station 98 may be positioned on the ground or, in some embodiments, may be portable and may be carried in a moving vehicle or aircraft. The Control station 98 is in communication with UAV 104 through a transceiver 96 and communications link 300. Any type of communications link that interfaces between the control station and UAV 104 to the Autopilot will work. UAV 104 regularly (typically as often as once per second) transmits its then current location to control station 98. At appropriate times, control station 98 transmits to UAV 104 one or more Targets 100, and UAV 104 navigates to those Targets

In one embodiment, an operator may use ground station software to identify the location of a Target and “see” the current location of the UAV on his control station monitor. Using a user interface of the ground station software the operator sets the location of the Simulated Target, as well as its speed, elevation and direction. The operator can then observe the changing position of the UAV. The display system showing the position of the UAV may overlap a map and is capable of zooming in on command. And information received from the UAV, such as from the UAV's cameras or other sensors, can be overlaid on a map and can be zoomed in on the operator's command.

In one embodiment, the tolerance for latency is sufficient to allow communications between the control station and the UAV via such communication media as a cellular network, satellite or retransfer, such as through IP over internet or telephone calls. In one embodiment, the UAV has a cellular connection to transponders connected to the internet. In yet another embodiment, the base station has a cellular connection to the internet which connects to a wireless communications device.

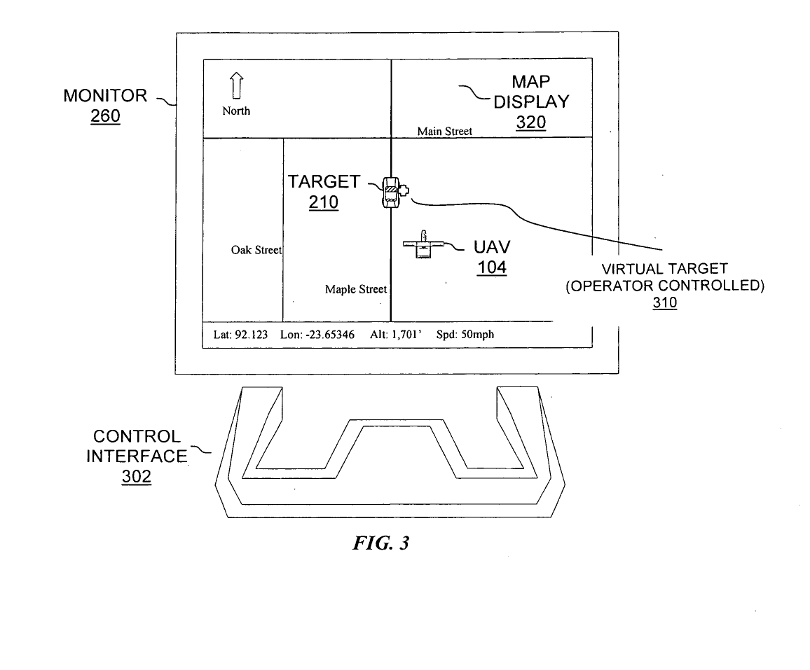

Targeting data can be communicated to the UAV in several alternative methods: (1) real-time, such as when tracking a moving vehicle such as an automobile; (2) “driving” a Simulated Target 114 on a display at the ground station such as shown in FIG. 3; or (3) preprogramming the intended path of a Target into the UAV's computer.

Although the invention has been described with reference to specific embodiments, this description is not meant to be constructed in a limited sense. The various modifications of the disclosed embodiments, as well as alternative embodiments of the invention, will become apparent to persons skilled in the art upon reference to the description of the invention. It is, therefore, contemplated that the appended claims will cover such modifications that fall within the scope of the invention, or their equivalents.

1-17. (canceled)

18. A method of operating an unmanned aerial vehicle (UAV) in hybrid flight mode, the method comprising:
providing a UAV;
providing a control station communicatively coupled to the UAV, the control station comprising:
a control interface; and
a heading offset indicator;
placing the UAV in a first position with a first velocity and first heading; and
manipulating the control interface to change the heading offset indicator, resulting in:
the control station sending target position data to the UAV; and
the UAV, in response to the target position data, following a path substantially corresponding to the target position data.

19. The method of claim 18 wherein:
the UAV comprises:
a navigation computer;
a position locator communicatively coupled to the navigation computer; and
control surfaces configured to actuate in response to control signals received from the navigation computer; and
the navigation computer is configured to:
compute a velocity vector in response to the target position data;
send control signals to the control surfaces to cause the UAV to substantially follow the velocity vector; and
receive feedback from the position locator.

20. The method of claim 19 wherein the position locator is a device selected from the group consisting of a global positioning system receiver, radar, and an inertial guidance system.

21. The method of claim 19 wherein the control station is communicatively coupled to the UAV over a medium selected from the group consisting of a cellular phone network, a satellite link, and an internet protocol.

22. The method of claim 21 wherein the medium has a communication latency of between 0.1 and four seconds.

23. The method of claim 18 wherein the control interface is a yoke.

24. The method of claim 18 wherein the control station further comprises:
a graphical user interface comprising:
a graphical representation of the UAV; and
a graphical representation of an altitude of the UAV;

25. The method of claim 24 wherein the graphical representation of an altitude of the UAV comprises a shadow indicator.

26. A method of operating an unmanned aerial vehicle (UAV) in autopilot flight mode, the method comprising:
providing a UAV, the UAV comprising:
a navigation computer;
a position locator communicatively coupled to the navigation computer; and
control surfaces configured to actuate in response to control signals from the navigation computer;
providing a control station communicatively coupled to the UAV, the control station comprising a target programming interface;
entering a target into the target programming interface, the target including a base position and an offset; and
sending the target to the UAV;
wherein the navigation computer is configured to actuate the control surfaces in response to the UAV receiving the target and to direct the UAV to a position corresponding substantially to the target.

27. The method of claim 26:
further comprising entering additional targets into the target programming interface; and
wherein the control station is configured to successively send the additional targets to the UAV, resulting in the UAV sequentially navigating to positions corresponding substantially to the additional targets.

28. The method of claim 27 further comprising:
providing a default target, wherein the UAV navigates to a position corresponding substantially to the default target if it reaches a final target and receives no other targets.

29. The method of claim 27 further comprising:
providing a default heading, wherein the UAV follows the default heading if it reaches a final target and receives no other targets.

30. A method of navigating an unmanned aerial vehicle in follow flight mode, the method comprising:
providing a UAV;
providing a tracking device configured to track a moving subject;
receiving from the tracking device a position of the moving subject; and
instructing the UAV to move to a position relative to the position of the moving subject.

31. The method of claim 30 wherein the tracking device comprises a ground station, the ground station comprising a graphic representing the subject overlaid on a map.

32. The method of claim 30 wherein the tracking device is affixed to the subject at manufacture.

33. The method of claim 30 wherein the tracking device is affixed to the subject in an emergency situation.

34. An unmanned aerial vehicle (UAV) comprising:
a navigation computer;
a position locator communicatively coupled to the navigation computer;
a transceiver communicatively coupling the navigation computer to a control station; and
control surfaces actuated in response to control signals from the navigation computer;
wherein the navigation computer is configured to:
receive a target from the control station, the target including a base position and an offset; and
generate control signals in response to the guidance instructions, resulting in the UAV moving to a position substantially in conformance with the target.

35. The UAV of claim 34 wherein the position locator is a device selected from the group consisting of a global positioning system receiver, radar, and an inertial guidance system.

36. The UAV of claim 34 wherein the transceiver communicatively couples the navigation computer to the control station over a medium selected from the group consisting of cellular phone network, a satellite link, and an internet protocol.

37. The UAV of claim 36 wherein the medium has a communication latency of between 0.1 and four seconds.

38. A method of using an unmanned aerial vehicle (UAV) for symbolic communication, the method comprising:
providing a UAV with an exterior surface color; and
causing the UAV to follow a flight path;
wherein the UAV color is selected to communicate a message and the flight path is selected to make the UAV visible to a target audience.

39. The method of claim 38 further comprising:
educating the target audience to associate the message with the surface color.

40. The method of claim 38 wherein the UAV has a wingspan of between six inches and eighty feet.

41. The method of claim 40 wherein the wingspan is between twelve feet and twenty-four feet.

42. The method of claim 38 wherein the UAV flies at an altitude between 10 feet above ground level (AGL) and 50,000 feet above sea level.

43. The method of claim 42 wherein the altitude is between 100 feet AGL and 10,000 feet AGL.

44. The method of claim 38 wherein the UAV hovers over the target audience.

45. The method of claim 38 wherein the UAV flies at a speed of up to mach 2.

46. The method of claim 45 wherein the speed is between 30 miles per hour (mph) and 130 mph.

47. The method of claim 38 wherein the UAV follows a landmark.

48. The method of claim 47 wherein the landmark is selected from the group consisting of a pipeline, a road and a river.

49. The method of claim 48 wherein the exterior surface color is provided by organic light-emitting diodes.

50. The method of claim 49 wherein the exterior surface color is dynamically configurable.
